(19) United States
(12) Patent Application Publication
(10) Pub. No.: US 2026/0214075 A1
(43) Pub. Date: Jul. 23, 2026

(54) DATA DISTRIBUTION METHOD

(71) Applicant: Tencent Technology (Shenzhen) Company Limited, Shenzhen (CN)

(72) Inventors: Yinchao YANG, Shenzhen (CN); Dongbo GU, Shenzhen (CN); Jing SHEN, Shenzhen (CN); Tianhang LI, Shenzhen (CN); Jun ZHANG, Shenzhen (CN); Miantao WAN, Shenzhen (CN); Chao PEI, Shenzhen (CN)

(73) Assignee: Tencent Technology (Shenzhen) Company Limited, Shenzhen, GD (CN)

(21) Appl. No.: 19/571,453

(22) Filed: Mar. 18, 2026

Related U.S. Application Data
(63) Continuation of application No. PCT/CN2024/106092, filed on Jul. 18, 2024.

(30) Foreign Application Priority Data
Nov. 16, 2023 (CN) 202311533384.9

(51) Int. Cl. H04L 9/40

(52) U.S. Cl. CPC H04L 63/0236; H04L 63/0272

(57) ABSTRACT

In a data distribution method, a cluster traffic-steering address and an inner protocol header of a first packet from a first end are obtained, and an address set corresponding to a plurality of gateway nodes in a gateway cluster is obtained based on the cluster traffic-steering address. A target address from the address set is selected based on the inner protocol header. The first packet is transmitted to a target gateway node corresponding to the target address, the target gateway node being configured to add address information to the first packet based on a node traffic-steering address corresponding to the target gateway node to the first packet. A second packet in association with the first packet from the second end is received, the second packet including the node traffic-steering address. The second packet is transmitted to the target gateway node corresponding to the node traffic-steering address.

### RELATED APPLICATIONS

The present application is a continuation of International Application No. PCT/CN2024/106092, filed on Jul. 18, 2024, which claims priority to Chinese Patent Application No. 202311533384.9, filed on Nov. 16, 2023 and entitled “DATA DISTRIBUTION METHOD, APPARATUS, DEVICE, AND STORAGE MEDIUM.” The entire disclosures of the prior applications are hereby incorporated by reference.

### FIELD OF THE TECHNOLOGY

This disclosure relates to the field of cloud technologies, including a data distribution method and apparatus, a device, a storage medium, and a program product.

### BACKGROUND OF THE DISCLOSURE

Driven by data calculation and high data availability, a data request volume gradually increases. In a single-server architecture in some applications, a single server cannot process all data requests, causing performance degradation or a system crash. Based on this, a load balancing gateway system and a server cluster are usually deployed in a large data center network. The load balancing gateway system is configured to distribute the data requests to a plurality of servers in the server cluster for processing, thereby improving data request processing efficiency.

To ensure data processing coherence, the load balancing gateway system in some applications may schedule all packets belonging to the same connection to the same server at a backend for processing, that is, achieve per connection consistency (PCC). Therefore, in some applications, the load balancing gateway system would store a cache file identifier (cookie id) and a connection hash value of each connection. Consequently, resource consumption of the load balancing gateway system may be excessively large, and stability and reliability of the load balancing gateway system may be further affected.

In addition, in some applications, only connection consistency of an upstream traffic (packets transmitted by a client to a server) can be ensured, and a downstream traffic (packets returned by the server to the client) may not be processed or distributed by the load balancing gateway system. In this case, a deviation exists in network traffic statistics collected by the load balancing gateway system, thereby affecting accuracy of traffic rate limiting, and further causing network congestion.

### SUMMARY

Embodiments of this disclosure provide a data distribution method and apparatus, a device, a storage medium, and a program product, to schedule upstream traffic and downstream traffic to the same target gateway node in a stateless manner, thereby improving connection consistency of upstream traffic and downstream traffic of the same connection. Examples of some embodiments of this disclosure are as follows.

According to an aspect, an embodiment of this disclosure provides a data distribution method. In the method, a cluster traffic-steering address and an inner protocol header of a first packet from a first end are obtained, and an address set corresponding to a plurality of gateway nodes in a gateway cluster is obtained based on the cluster traffic-steering address. A target address from the address set is selected by processing circuitry of a data distribution device based on the inner protocol header. The first packet is transmitted by the processing circuitry to a target gateway node corresponding to the target address, the target gateway node being configured to add address information to the first packet based on a node traffic-steering address corresponding to the target gateway node to the first packet and to transmit the first packet with inclusion of the node traffic-steering address to a second end. A second packet in association with the first packet from the second end is received, the second packet including the node traffic-steering address. The second packet is transmitted to the target gateway node corresponding to the node traffic-steering address, the target gateway node being further configured to transmit the second packet to the first end.

According to an aspect, an embodiment of this disclosure provides a data communication method. In the method, a first packet from a data distribution device is received by processing circuitry of a target gateway node based on a target address corresponding to the target gateway node, the data distribution device being configured to obtain a cluster traffic-steering address and an inner protocol header of the first packet from a first end, obtain an address set corresponding to a plurality of gateway nodes in a gateway cluster based on the cluster traffic-steering address, and obtain the target address from the address set based on the inner protocol header. A node traffic-steering address corresponding to the target gateway node is added by the processing circuitry to the first packet. The first packet with inclusion of the node traffic-steering address is transmitted to a second end. A second packet in association with the first packet is received by the processing circuitry from the data distribution device, the data distribution device being configured to receive the second packet from the second end, and the second packet carrying the node traffic-steering address. The second packet is transmitted to the first end.

According to an aspect, an embodiment of this disclosure provides a data distribution apparatus. The data distribution apparatus includes processing circuitry configured to obtain a cluster traffic-steering address and an inner protocol header of a first packet from a first end, and to obtain an address set corresponding to a plurality of gateway nodes in a gateway cluster based on the cluster traffic-steering address. The processing circuitry is configured to select a target address from the address set based on the inner protocol header. The processing circuitry is configured to transmit the first packet to a target gateway node corresponding to the target address, the target gateway node being configured to add address information based on a node traffic-steering address corresponding to the target gateway node to the first packet and to transmit the first packet with inclusion of the node traffic-steering address to a second end. The processing circuitry is configured to receive a second packet in association with the first packet from the second end, the second packet including the node traffic-steering address. The processing circuitry is configured to transmit the second packet to the target gateway node corresponding to the node traffic-steering address, the target gateway node being further configured to transmit the second packet to the first end.

According to an aspect, an embodiment of this disclosure provides a data communication apparatus. The data communication apparatus includes processing circuitry configured to receive a first packet from a data distribution device based on a target address corresponding to the target gateway node, the data distribution device being configured to obtain a cluster traffic-steering address and an inner protocol header of the first packet from a first end, obtain an address set corresponding to a plurality of gateway nodes in a gateway cluster based on the cluster traffic-steering address, and obtain the target address from the address set based on the inner protocol header. The processing circuitry is configured to add a node traffic-steering address corresponding to the target gateway node to the first packet. The processing circuitry is configured to transmit the first packet with inclusion of the node traffic-steering address to a second end. The processing circuitry is configured to receive a second packet in association with the first packet from the data distribution device, the data distribution device being configured to receive the second packet from the second end, and the second packet carrying the node traffic-steering address. The processing circuitry is configured to transmit the second packet to the first end.

According to an aspect, an embodiment of this disclosure provides a data distribution method, including: parsing a request packet transmitted by a transmitting end, to obtain a cluster traffic-steering address and an inner protocol header; determining a gateway cluster corresponding to the cluster traffic-steering address, and obtaining an address set corresponding to a plurality of gateway nodes in the gateway cluster; select a target address matching the inner protocol header from the address set, and transmit the request packet to a target gateway node corresponding to the target address, to cause the target gateway node to add a node traffic-steering address corresponding to the target gateway node to the request packet, and transmit the request packet to a receiving end; receiving, from the receiving end, a reply packet carrying the node traffic-steering address; and transmitting the reply packet to the target gateway node corresponding to the node traffic-steering address, to cause the target gateway node to transmit the reply packet to the transmitting end.

According to another aspect, an embodiment of this disclosure further provides a data distribution method, including: receiving a request packet transmitted by a data distribution device based on a target address corresponding to a target gateway node, the data distribution device receiving the request packet from a transmitting end, parsing the request packet to obtain a cluster traffic-steering address and an inner protocol header, determining a gateway cluster corresponding to the cluster traffic-steering address, obtaining an address set corresponding to a plurality of gateway nodes in the gateway cluster, and selecting a target address matching the inner protocol header from the address set; transmitting the request packet to a receiving end after adding a node traffic-steering address corresponding to the target gateway node to the request packet, the data distribution device receiving a reply packet carrying the node traffic-steering address from the receiving end; receiving the reply packet transmitted by the data distribution device based on the node traffic-steering address; and transmitting the reply packet to the transmitting end.

According to another aspect, an embodiment of this disclosure further provides a data distribution apparatus, including: a parsing module, configured to parse a request packet transmitted by a transmitting end, to obtain a cluster traffic-steering address and an inner protocol header; a matching module, configured to: determine a gateway cluster corresponding to the cluster traffic-steering address, and obtain an address set corresponding to a plurality of gateway nodes in the gateway cluster; and select a target address matching the inner protocol header from the address set, and transmit the request packet to a target gateway node corresponding to the target address, to cause the target gateway node to add a node traffic-steering address corresponding to the target gateway node to the request packet, and transmit the request packet to a receiving end; a first receiving module, configured to receive, from the receiving end, a reply packet carrying the node traffic-steering address; and a first transmitting module, configured to transmit the reply packet to the target gateway node corresponding to the node traffic-steering address, to cause the target gateway node to transmit the reply packet to the transmitting end.

According to another aspect, an embodiment of this disclosure further provides a data distribution apparatus, including: a second receiving module, configured to receive a request packet transmitted by a data distribution device based on a target address corresponding to a target gateway node, the data distribution device receiving the request packet from a transmitting end, parsing the request packet to obtain a cluster traffic-steering address and an inner protocol header, determining a gateway cluster corresponding to the cluster traffic-steering address, obtaining an address set corresponding to a plurality of gateway nodes in the gateway cluster, and selecting a target address matching the inner protocol header from the address set; a processing module, configured to add a node traffic-steering address corresponding to the target gateway node to the request packet; and a second transmitting module, configured to transmit the request packet to a receiving end, the data distribution device receiving a reply packet carrying the node traffic-steering address from the receiving end, the second receiving module being further configured to receive the reply packet transmitted by the data distribution device based on the node traffic-steering address; and the second transmitting module being further configured to transmit the reply packet to the transmitting end.

According to another aspect, an embodiment of this disclosure further provides a computer device, including a memory (e.g., a non-transitory computer-readable storage medium), processing circuitry (e.g., a processor), and a computer program stored in the memory and capable of being run on the processor, the processor implementing operations of the foregoing data distribution method when executing the program.

According to another aspect, an embodiment of this disclosure further provides a non-transitory computer-readable storage medium, having a computer program capable of being executed by a computer device stored therein, when the program is run on the computer device, the computer device being caused to perform operations of the foregoing data distribution method.

According to another aspect, an embodiment of this disclosure further provides a computer program product, including a computer program stored in a non-transitory computer-readable storage medium, the computer program including program instructions, and when the program instructions are executed by a computer device, the computer device being caused to perform operations of the foregoing data distribution method.

### BRIEF DESCRIPTION OF THE DRAWINGS

To describe the technical solutions in the embodiments of the present disclosure, the following briefly describes the accompanying drawings. The accompanying drawings in the following descriptions show merely some embodiments of the disclosure, and a person of ordinary skill in the art may still derive other drawings from these accompanying drawings.

FIG. 1 is a schematic structural diagram of a system architecture according to an embodiment of this disclosure.

FIG. 2 is a schematic flowchart of a data distribution method according to an embodiment of this disclosure.

FIG. 3 is a schematic flowchart of a method for distribution upstream traffic according to an embodiment of this disclosure.

FIG. 4 is a schematic flowchart of a method for distribution downstream traffic according to an embodiment of this disclosure.

FIG. 5 is a schematic flowchart of a data distribution method according to an embodiment of this disclosure.

FIG. 6 is a schematic flowchart of a data distribution method according to an embodiment of this disclosure.

FIG. 7 is a schematic flowchart of a data distribution method according to an embodiment of this disclosure.

FIG. 8 is a schematic diagram of a priority backup group according to an embodiment of this disclosure.

FIG. 9 is a schematic structural diagram of a data distribution apparatus according to an embodiment of this disclosure.

FIG. 10 is a schematic structural diagram of a data distribution apparatus according to an embodiment of this disclosure.

FIG. 11 is a schematic structural diagram of a computer device according to an embodiment of this disclosure.

### DESCRIPTION OF EMBODIMENTS

To describe the objectives, technical solutions, and beneficial effects of the present disclosure, the following further describes the present disclosure with reference to the accompanying drawings and embodiments. Embodiments described should not be construed as a limitation on this disclosure. Other embodiments are within the scope of this disclosure.

For ease of understanding, examples of terms involved in the embodiments of the present disclosure are described below. The description of the terms are provided as examples only and are not intended to limit the scope of the disclosure.

A cloud technology may correspond to a collective name of a network technology, an information technology, an integration technology, a platform management technology, an application technology, and the like based on a cloud computing business mode. A cloud technology may be configured to form a resource pool that may be accessed as needed, which provides flexibility and convenience. In some embodiments of this disclosure, data distribution is performed to implement load balancing based on the cloud technology.

A private cloud may refer to creating a cloud infrastructure and software/hardware resources behind a firewall, for departments in an institution or an enterprise to share resources in a data center. A private cloud may be implemented based on the hardware resources as well as cloud device (Infrastructure as a Service, IaaS) software. The data distribution method according to one or more embodiments of this disclosure may be deployed in a private cloud.

Virtual private cloud (VPC): A virtual private cloud may correspond to a dynamic configuration pool of public cloud computing resources. A VPC may enable data transmission between a private enterprise and a cloud service provider by using an encryption protocol, a tunneling protocol, and another security program. The VPC may change a multi-tenant architecture of the cloud service provider into a single-tenant architecture.

Virtual private cloud identifier (VPCID): A virtual private cloud identifier may correspond to an identifier configured to uniquely identify a virtual private cloud in a cloud computing service.

Programming protocol independent packet processor (P4): A programming protocol independent packet processor may correspond to a hardware programming language unrelated to a protocol.

Load balance (LB): Load balance may correspond to allocating workload between a plurality of server nodes, to improve system reliability and efficiency.

Real server (RS): A real server may correspond to, in a load balancing application scenario, a server node that is located at a backend and to which a load is allocated.

Per connection consistency (PCC): Per connection consistency may correspond to a data packet in the same data flow being scheduled to the same server node at the backend.

Stateful gateway: A stateful gateway may correspond to a network-connected gateway configured to record and maintain every connections associated thereto.

VPCGW gateway: In this disclosure, a VPCGW corresponds to an example of a layer-four load balancing gateway.

Network address translation (NAT): Network address translation may correspond to mapping one network address space to another network address space.

FULL NAT: Fully NAT may correspond to simultaneously translating a source IP address, a destination IP address, a source port address, and a destination port address of a packet. In a load balancing application scenario, in NAT mode, after receiving a request packet transmitted by a client, a data distribution device may modify a destination IP address of the request packet into an IP address of a backend real server, and may modify a destination port number of the request packet into a port number of the real server. In FULL NAT mode, after receiving a request packet transmitted by a client, a data distribution device may modify a source IP address of the request packet into an internal IP address of the data distribution device, may modify a source port number of the request packet into an internal port number of the data distribution device, may modify a destination IP address of the request packet into an IP address of a backend real server, and may modify a destination port number of the request packet into a port number of the real server.

Generic routing encapsulation (GRE): A generic routing encapsulation may correspond to a network protocol, and may be configured to encapsulate various network layer protocols in a network.

Border gateway protocol (BGP): A border gateway protocol may correspond to a dynamic routing protocol configured to exchange routing information between autonomous systems.

Equal-cost multi-path (ECMP): An equal-cost multi-path may correspond to a network routing technology, which allows a data packet to implement load balancing between a plurality of paths having the same costs (such as hop count, bandwidth, and delay). A main objective of ECMP may correspond to improve network availability, fault tolerance, and bandwidth utilization.

Open shortest path first (OSPF): Open shortest path first may correspond to an open internal routing protocol, and may be configured to transfer routing information inside an autonomous system.

Central processing unit (CPU): A central processing unit may correspond to a primary processor in a computational device.

The following describes design ideas of the embodiments of this disclosure as non-limiting examples.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In some applications, a load balancing gateway system is usually deployed in a large data center network, to implement service distribution and horizontal expansion of a cloud data center service. The load balancing gateway system includes a key basic requirement, that is, implementing connection consistency.

Therefore, in the related art, for the first packet of each connection transmitted by the client, the load balancing gateway system schedules a corresponding server IP address, generates a cache file identifier (cookie id) and a connection hash value corresponding to the connection, and stores a connection relationship table of the cookie id, the connection hash value, and the server IP address. When receiving a subsequent packet, the load balancing gateway system calculates the connection hash value based on the cookie id carried in the subsequent packet and a packet header of the subsequent packet, queries the connection relationship table to obtain the server IP address, and then forwards the subsequent packet to the server based on the server IP address. The server returns a response packet to the client through a common gateway, and the response packet is not split by the load balancing gateway system.

In the foregoing technical solution, the load balancing gateway system needs to store a cookie id and a connection hash value of each connection. Consequently, resource consumption of the load balancing gateway system is excessively large, and stability and reliability of the load balancing gateway system are further affected.

In addition, in the foregoing technical solution, only connection consistency of upstream traffic (including packets transmitted by the client to the server) can be ensured, and downstream traffic (including packets returned by the server to the client) is no longer split by the load balancing gateway system. In this case, a deviation exists in network traffic statistics collected by the load balancing gateway system, thereby affecting accuracy of traffic rate limiting, and further causing network congestion.

In view of this, an embodiment of this disclosure provides a data distribution method. In the method, for the upstream traffic, the data distribution device parses a request packet transmitted by a transmitting end, to obtain a cluster traffic-steering address and an inner protocol header. Then, a corresponding gateway cluster is determined based on the cluster traffic-steering address, and an address set corresponding to a plurality of gateway nodes included in the gateway cluster is obtained. Then, a target address matching the inner protocol header is selected from the address set, and the request packet is transmitted to a corresponding target gateway node based on the target address. After adding a node traffic-steering address corresponding to the target gateway node to the request packet, the target gateway node transmits the request packet to a receiving end.

For the downstream traffic, the data distribution device receives a reply packet that carries the node traffic-steering address and that is returned by the receiving end. Then, the reply packet is transmitted to the target gateway node associated with the node traffic-steering address, and the target gateway node transmits the reply packet to the transmitting end.

In this embodiment of this disclosure, the data distribution device distributes the traffic through the cluster traffic-steering address or the node traffic-steering address carried in the packet, and a cookie id and a connection hash value of each connection do not need to be stored. In other words, the data distribution device in this disclosure is implemented in a stateless manner. In this way, storage resource occupation can be greatly reduced, thereby improving stability and reliability of the data distribution device.

Second, for the upstream traffic, the data distribution device schedules the request packet to the target gateway node based on the cluster traffic-steering address in the request packet and the inner protocol header of the request packet, and the target gateway node forwards the request packet to the receiving end. For the downstream traffic, the data distribution device also schedules the reply packet to the target gateway node based on the node traffic-steering address that is carried in the reply packet and that corresponds to the target gateway node, and the target gateway node forwards the reply packet to the transmitting end. In this way, the upstream traffic and the downstream traffic are both scheduled to the same target gateway node, connection consistency between upstream traffic and downstream traffic of the same connection is ensured, and traffic jitter is effectively resolved. In addition, when network traffic statistics are collected, accuracy is higher, thereby improving accuracy of traffic rate limiting, and avoiding network congestion.

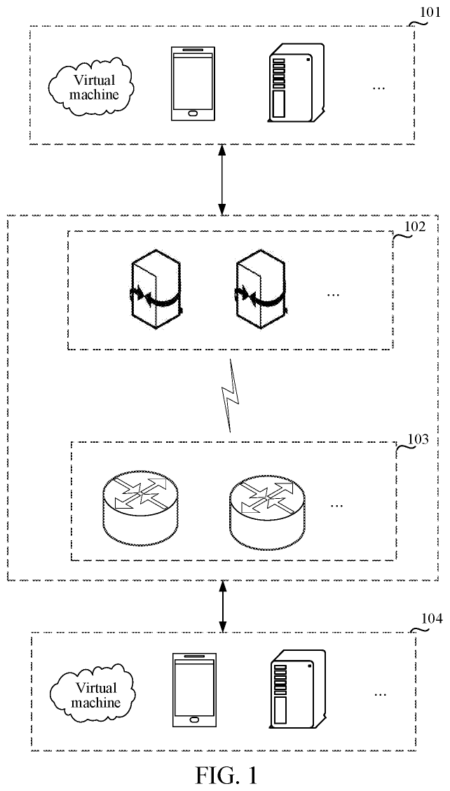

FIG. 1 is a diagram of a system architecture to which an embodiment of this disclosure is applied. The system architecture includes at least a transmitting end 101, a traffic scheduling layer 102, a gateway cluster layer 103, and a receiving end 104.

The traffic scheduling layer 102 is configured to schedule a received packet to the gateway cluster layer 103. In one example, a single network data distribution device (a data distribution device for short) or a data distribution device cluster including a plurality of data distribution devices may be deployed on the traffic scheduling layer 102. The data distribution device supports clustered deployment, and may be expanded horizontally in various manners.

In some embodiments, the data distribution device may be implemented through a programmable switching chip. A single data distribution device node can achieve a Tbps distribution capability, and have advantages such as being stateless, high-bandwidth, and low-latency. The data distribution device may alternatively be implemented by using a common CPU server. This is not specifically limited in this disclosure. In addition, in this embodiment of this disclosure, the data distribution device uses a stateless design solution, and has high stability and reliability.

The gateway cluster layer 103 includes various types of stateful or stateless gateway clusters. The gateway cluster layer 103 is deployed at a backend of the traffic scheduling layer 102, and receives a data request scheduled by the traffic scheduling layer 102 at a frontend. In one example, in a physical topology, the gateway cluster layer 103 and the traffic scheduling layer 102 may span any three layers of networks. The gateway cluster layer 103 also supports upgrading a gateway of a single network adapter to a gateway of a multi-network adapter, thereby greatly improving entire-machine performance of a backend gateway.

One or more transmitting ends 101 are provided, and one or more receiving ends 104 are also provided. A quantity of the transmitting ends 101 and a quantity of the receiving ends 104 are not specifically limited in this disclosure.

The transmitting end 101 and the receiving end 104 may each be a virtual machine in a VPC cloud network. Certainly, the transmitting end 101 and the receiving end 104 may alternatively be terminal devices such as a smartphone, a tablet computer, a notebook computer, a desktop computer, a smart household appliance, a smart voice interaction device, and a smart in-vehicle device. The transmitting end 101 and the receiving end 104 may further be independent physical servers, or may be a server cluster or distributed system including a plurality of physical servers, or may be a cloud server for providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto.

A packet in a direction of the transmitting end 101 to the receiving end 104 may be referred to as upstream traffic, and a packet in a direction of the receiving end 104 to the transmitting end 101 may be referred to as downstream traffic.

In one example, the data distribution method in this embodiment of this disclosure may be applied to scenarios such as inter-node traffic distribution, lossless traffic migration between new and old clusters, cross-cluster disaster tolerance, cross-available area/cross-region disaster tolerance, and multi-tenant traffic isolation.

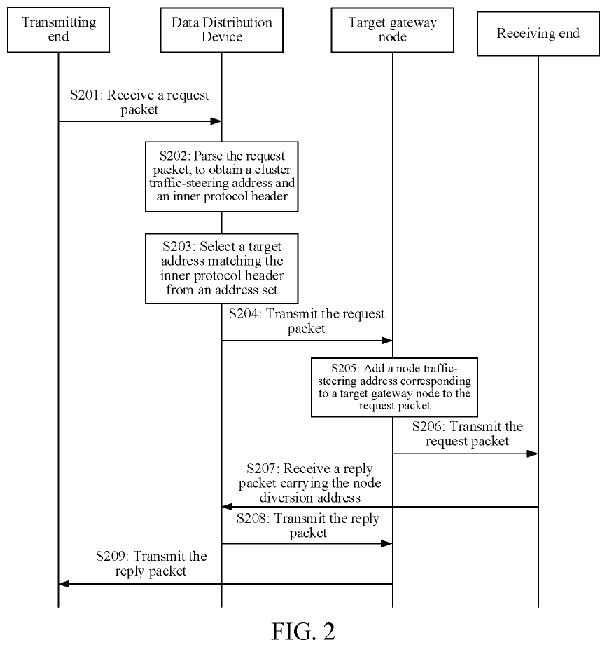

Based on the system architecture diagram shown in FIG. 1, an embodiment of this disclosure provides a process of a data distribution method. As shown in FIG. 2, the process of the method is interactively performed by the transmitting end, the data distribution device, the target gateway node, and the receiving end shown in FIG. 1. The computer device in this embodiment of this disclosure includes the data distribution device and the target gateway node. In an example, the data distribution device is located on the traffic scheduling layer, and the target gateway node is located on the gateway cluster layer. The method includes the following operations.

Operation S201: The data distribution device receives a request packet (also referred to as a first packet) transmitted by the transmitting end (also referred to as a first end).

In an example, the transmitting end may be a virtual machine in a VPC cloud network, or may be a terminal device, a server, or the like.

The request packet carries a first outer protocol header, a cluster traffic-steering address, and an inner protocol header.

Operation S202: The data distribution device parses the request packet, to obtain the cluster traffic-steering address and the inner protocol header. For example, a cluster traffic-steering address and an inner protocol header of a first packet from a first end are obtained.

In an example, the cluster traffic-steering address refers to: an internet protocol (IP) address (that is, cluster_director_ip) that is bound to the data distribution device and that diverts the gateway cluster in advance, and therefore, the cluster traffic-steering address may also be referred to as a cluster traffic-steering IP address. A cluster traffic-steering address may be allocated to each gateway cluster in a backend gateway cluster layer. A plurality of cluster traffic-steering addresses may be bound to a data distribution device, to implement traffic scheduling for a plurality of gateway clusters in the gateway cluster layer.

In addition to being bound to the cluster traffic-steering address, the data distribution device is further bound to a node traffic-steering address. The node traffic-steering address refers to: an IP address (that is, node_director_ip) that is bound to the data distribution device and that diverts a single gateway node in advance, and therefore, the node traffic-steering address may also be referred to as a node traffic-steering IP address. An independent node traffic-steering address may be allocated to each of the gateway nodes in all the gateway clusters in the backend gateway cluster layer. A plurality of node traffic-steering addresses may be bound to a data distribution device, to implement traffic scheduling for a plurality of gateway nodes in the gateway cluster layer.

After being bound to the cluster traffic-steering address and the node traffic-steering address, the data distribution device issues a dynamic route of all the cluster traffic-steering addresses and all the node traffic-steering addresses, to attract service flow to the data distribution device.

After receiving the request packet transmitted by the transmitting end, the data distribution device performs packet protocol header parsing on the request packet, to obtain the first outer protocol header and the inner protocol header, a destination IP address of the first outer protocol header being the cluster traffic-steering address, and the inner protocol header includes: a source IP address, a destination IP address, an identifier of a virtual private cloud in which the transmitting end is located, a source port number, and a destination port number.

Although the cluster traffic-steering address and the node traffic-steering address are bound to the data distribution device in advance, adjustment performed on the bound cluster traffic-steering address and node traffic-steering address is also supported in a subsequent distribution process. This is not specifically limited in this disclosure.

Operation S202: Determine a gateway cluster corresponding to the cluster traffic-steering address, and obtain an address set corresponding to a plurality of gateway nodes in the gateway cluster. For example, an address set corresponding to a plurality of gateway nodes in a gateway cluster is obtained based on the cluster traffic-steering address.

In an example, a distribution rule set is set in the data distribution device. The distribution rule set includes a plurality of distribution rules, and each distribution rule includes: a traffic-steering address and an address set of a next-hop gateway node, a type of the traffic-steering address including: the cluster traffic-steering address and the node traffic-steering address.

When the traffic-steering address is the cluster traffic-steering address, the address set of the next-hop gateway node includes: the address set corresponding to the plurality of gateway nodes in the gateway cluster corresponding to the cluster traffic-steering address, including an address corresponding to each gateway node. When the plurality of cluster traffic-steering addresses is bound to the data distribution device, the distribution rule set correspondingly includes distribution rules respectively corresponding to the plurality of cluster traffic-steering addresses.

When the traffic-steering address is the node traffic-steering address, the address set of the next-hop gateway node includes: an address of a gateway node corresponding to the node traffic-steering address. When the plurality of node traffic-steering addresses is bound to the data distribution device, the distribution rule set correspondingly includes distribution rules respectively corresponding to the plurality of node traffic-steering addresses.

For example, Table 1 is a distribution rule table according to an embodiment of this disclosure.

TABLE 1
Distribution rule table

| Sequence number of | Traffic-steering | Address set of a |
|---|---|---|
| a distribution rule | address | next-hop gateway node |
| 1 | cluster_director_ip | backend_node0_ip, |
| | | backend_node1_ip, |
| | | backend_node2_ip, |
| | | and backend_node3_ip |
| 2 | node0_director_ip | backend_node0_ip |
| 3 | node1_director_ip | backend_node1_ip |
| 4 | node2_director_ip | backend_node2_ip |
| 5 | node3_director_ip | backend_node3_ip |

The distribution rule table includes five distribution rules, sequence numbers of which are respectively 1 to 5.

A traffic-steering address of the distribution rule 1 is: the cluster traffic-steering IP address (cluster_director_ip); and an address set of a next-hop gateway node in the distribution rule 1 includes: an IP address of a gateway node 0 (backend_node0_ip), an IP address of a gateway node 1 (backend_node1_ip), an IP address of a gateway node 2 (backend_node2_ip), and an IP address of a gateway node 3 (backend_node3_ip).

A traffic-steering address of the distribution rule 2 is: a node traffic-steering IP address (node0_director_ip) corresponding to the gateway node 0; and an address set of a next-hop gateway node in the distribution rule 2 includes: the IP address of the gateway node 0 (backend_node0_ip).

A traffic-steering address of the distribution rule 3 is: a node traffic-steering IP address (node1_director_ip) corresponding to the gateway node 1; and an address set of a next-hop gateway node in the distribution rule 3 includes: the IP address (backend_node1_ip) of the gateway node 1.

A traffic-steering address of the distribution rule 4 is: a node traffic-steering IP address (node2_director_ip) corresponding to the gateway node 2; and an address set of a next-hop gateway node in the distribution rule 4 includes: the IP address (backend_node2_ip) of the gateway node 2.

A traffic-steering address of the distribution rule 5 is: a node traffic-steering IP address (node3_director_ip) corresponding to the gateway node 3; and an address set of a next-hop gateway node in the distribution rule 5 includes: the IP address (backend_node3_ip) of the gateway node 3.

The distribution rule set (also referred to as a candidate distribution rule set) is preset in the data distribution device, and adjustment performed on the distribution rule set is also supported in the subsequent distribution process. This is not specifically limited in this disclosure.

In some embodiments, after obtaining the cluster traffic-steering address from the request packet, the data distribution device obtains a first distribution rule matching the cluster traffic-steering address from the preset distribution rule set, and the first distribution rule includes: the cluster traffic-steering address and an address set corresponding to a plurality of gateway nodes included in a corresponding gateway cluster.

In an example, the cluster traffic-steering address is compared with a traffic-steering address of each distribution rule in the distribution rule set, to determine the matched first distribution rule. Then, an address set of a next-hop gateway node corresponding to the first distribution rule in the distribution rule set is obtained, that is, the address set corresponding to the plurality of gateway nodes in the gateway cluster corresponding to the cluster traffic-steering address.

Operation S203: The data distribution device selects a target address matching the inner protocol header from the address set. For example, a target address from the address set is selected by processing circuitry of a data distribution device based on the inner protocol header.

In some embodiments, a target distribution policy matching the inner protocol header is selected from a plurality of distribution policies; and field information associated with the target distribution policy is obtained from the inner protocol header. Then, hash calculation is performed on the field information, to obtain a target hash value. Then, an address that is in the address set and that matches the target hash value is determined as the target address.

In an example, a distribution policy set is preset in the data distribution device. For different distribution policies in the distribution policy set, field information correspondingly obtained from the inner protocol header for hash calculation is also different, that is, input fields of a hash algorithm are different. In a hash calculation process, the hash algorithm used includes, but is not limited to: an SHA algorithm and an SM3 algorithm.

In one example, the distribution policy in the distribution policy set may be set based on an actual situation, and subsequent adjustment may be supported.

For example, Table 2 is a schematic diagram of a distribution policy table according to an embodiment of this disclosure.

TABLE 2
Distribution policy table

| Policy name | Input field of a hash algorithm |
|---|---|
| Flow granularity-based | Source IP address, destination IP address, |
| distribution policy | VPCID, |
| | source port number, and destination port |
| | number |
| Service granularity-based | VPCID, destination IP address, and |
| distribution policy | destination port number |
| Virtual private cloud | VPCID |
| granularity-based | |
| distribution policy | |
| Tenant granularity-based | Tenant identifier corresponding to a VPCID |
| distribution policy | |

Content of a table header of the distribution policy table includes: the policy name and the input field of the hash algorithm.

The distribution policy set includes the following distribution policies: the distribution policy using a flow as a granularity (flow granularity-based distribution policy), the distribution policy using a service as a granularity (service granularity-based distribution policy), the distribution policy using a virtual private cloud as a granularity (virtual private cloud granularity-based distribution policy), and the distribution policy using a tenant as a granularity (tenant granularity-based distribution policy).

In an example, the distribution policy using a flow as a granularity refers to that: 5-tuple content, that is, the source IP address, the destination IP address, the VPCID, the source port number, and the destination port number in the inner protocol header of the packet is used as the input field of the hash algorithm to perform hash calculation, to obtain a hash value, an IP address of the next-hop gateway node is obtained through querying based on the hash value, and then the packet is scheduled to the next-hop gateway node. In this way, packets with the same 5-tuple content can be scheduled to the same gateway node at the backend. In one example, the distribution policy using a flow as a granularity may be used as a system default distribution policy.

The distribution policy using a service as a granularity refers to that: the VPCID, the destination IP address, and the destination port number in the inner protocol header of the packet are used as the input fields of the hash algorithm to perform hash calculation, to obtain a hash value, an IP address of the next-hop gateway node is obtained through querying based on the hash value, and then the packet is scheduled to the next-hop gateway node. In this way, it is ensured that packets with the same destination IP address and destination port number can always be scheduled to the same gateway node at the backend.

The distribution policy using a virtual private cloud as a granularity refers to that: the VPCID in the inner protocol header of the packet is used as the input field of the hash algorithm to perform hash calculation, to obtain a hash value, an IP address of the next-hop gateway node is obtained through querying based on the hash value, and then the packet is scheduled to the next-hop gateway node. In this way, it is ensured that packets with the same VPCID can always be scheduled to the same gateway node at the backend.

The distribution policy using a tenant as a granularity refers to that: the tenant identifier corresponding to the VPCID in the inner protocol header of the packet is used as the input field of the hash algorithm to perform hash calculation, to obtain a hash value. A tenant corresponds to one or more VPCIDs. An IP address of the next-hop gateway node is obtained through querying based on the hash value, and then the packet is scheduled to the next-hop gateway node. In this way, it is ensured that packets with the same VPCID can always be scheduled to the same gateway node at the backend.

The target distribution policy may be selected from the distribution policy set, or may be a default distribution policy. After the target distribution policy is determined, the associated field information is obtained from the inner protocol header according to the target distribution policy, and hash calculation is performed on the field information, to obtain the target hash value. An IP address of the gateway node that is in the address set of the next-hop gateway node and that is the same as the target hash value is used as the target address matching the inner protocol header.

In one example, in this embodiment of this disclosure, the target distribution policy is selected from the distribution policy set by using at least the following several implementation manners.

Implementation manner 1: Priorities of the plurality of distribution policies in the distribution policy set are preset.

In a distribution process as a non-limiting example, the inner protocol header matches the plurality of distribution policies in sequence based on a descending order of the priorities, until the matched target distribution policy is obtained.

In an example, a distribution policy of a first priority is first obtained, and then a specific value of the input field of the hash algorithm included in the distribution policy is compared with a specific value of a related field in the inner protocol header of the request packet. If the specific value of the input field of the hash algorithm included in the distribution policy is consistent with the specific value of the related field in the inner protocol header of the request packet, the distribution policy of the first priority is used as the matched target distribution policy. If the specific value of the input field of the hash algorithm included in the distribution policy is not consistent with the specific value of the related field in the inner protocol header of the request packet, a distribution policy of a second priority is obtained, and the matching process continues to be performed. The rest can be deduced by analogy, until the matched target distribution policy is found. If there is no matched target distribution policy in the plurality of distribution policies, a traffic scheduling failure message is returned.

Implementation manner 2: The distribution policy using a flow as a granularity is set as a system default distribution policy, and priorities of other distribution policies in the distribution policy set are set.

In a distribution process as a non-limiting example, the inner protocol header matches the other distribution policies in sequence based on a descending order of the priorities, until the matched target distribution policy is obtained. A specific matching manner is described above. Details are not described herein again. If no matched target distribution policy is found in the other distribution policies, the distribution policy using a flow as a granularity is used as the target distribution policy.

Implementation manner 3: A distribution policy (for example, the distribution policy using a flow as a granularity) is selected in advance from the distribution policy set as the system default distribution policy. In a distribution process as a non-limiting example, the system default distribution policy is directly used as the target distribution policy.

A manner of obtaining the target distribution policy through matching is not limited to the foregoing several implementation manners, and may be another implementation manner. This is not specifically limited in this disclosure.

In a distribution process as a non-limiting example, when the target distribution policy is the distribution policy using a flow as a granularity, the field information obtained from the inner protocol header of the request packet includes: the source IP address, the destination IP address, the identifier of the virtual private cloud in which the transmitting end is located, the source port number, and the destination port number.

When the target distribution policy is the distribution policy using a service as a granularity, the field information obtained from the inner protocol header of the request packet includes: the identifier of the virtual private cloud in which the transmitting end is located, the destination IP address, and the destination port number.

When the target distribution policy is the distribution policy using a virtual private cloud as a granularity, the field information obtained from the inner protocol header of the request packet includes: the identifier of the virtual private cloud in which the transmitting end is located.

When the target distribution policy is the distribution policy using a tenant as a granularity, the field information obtained from the inner protocol header of the request packet includes: a tenant identifier corresponding to the identifier of the virtual private cloud in which the transmitting end is located.

In this embodiment of this disclosure, the plurality of distribution policies such as the distribution policy using a flow as a granularity, the distribution policy using a service as a granularity, the distribution policy using a virtual private cloud as a granularity, and the distribution policy using a tenant as a granularity are preset. Therefore, in the distribution process example, a specific distribution policy may be selected based on an actual situation, and traffic scheduling is performed according to the distribution policy, thereby improving flexibility of traffic scheduling.

Operation S204: The data distribution device transmits the request packet to a target gateway node corresponding to the target address. For example, the first packet is transmitted to a target gateway node corresponding to the target address. In some embodiments, the target gateway node is configured to modify the first packet based on adding a node traffic-steering address corresponding to the target gateway node to the first packet and to transmit the first packet with inclusion of the node traffic-steering address to a second end (also referred to as a receiving end).

In an example, the data distribution device modifies the destination IP address of the first outer protocol header of the request packet into the target address, and then transmits the request packet to a corresponding target gateway node.

Operation S205: The target gateway node adds a node traffic-steering address corresponding to the target gateway node to the request packet.

Operation S206: The target gateway node transmits the request packet to the receiving end.

In an example, after receiving the request packet, the target gateway node executes specific service logic of the target gateway node, where gateway logic may be different in different application scenarios. Then, a source IP address of the first outer protocol header of the request packet is modified into the node traffic-steering address corresponding to the target gateway node. Then, the request packet is transmitted to a corresponding receiving end.

In some complex gateway scenarios such as load balancing, the request packet may need to be forwarded in FULL NAT mode. In this case, the modified source IP address, destination IP address, source port number, and destination port number all refer to the source IP address, the destination IP address, the source port number, and the destination port number in the inner protocol header. When the data distribution device performs traffic or data distribution, the request packet is scheduled to the target gateway node mainly by modifying the destination IP address of the outer protocol header of the request packet. Therefore, this disclosure supports implementing symmetric distribution in FULL NAT mode, and ensures connection consistency of upstream traffic and downstream traffic.

Operation S207: The data distribution device receives, from the receiving end, a reply packet (also referred to as a second packet) carrying the node traffic-steering address. For example, a second packet in association with the first packet from the second end is received, and the second packet carries the node traffic-steering address.

In an example, after receiving the request packet, the receiving end obtains the node traffic-steering address corresponding to the target gateway node from the outer protocol header of the request packet. In addition, service data in a packet body of the request packet is processed. After processing is completed, the receiving end generates the reply packet corresponding to the request packet, and transmits the reply packet to the data distribution device, the reply packet carrying: the node traffic-steering address corresponding to the target gateway node.

The data distribution device performs packet protocol header parsing on the reply packet, to obtain a destination IP address of a second outer protocol header, that is, the node traffic-steering address of the target gateway node.

Operation S208: The data distribution device transmits the reply packet to the target gateway node corresponding to the node traffic-steering address. For example, the second packet is transmitted to the target gateway node corresponding to the node traffic-steering address. In some embodiments, the target gateway node is further configured to transmit the second packet to the first end.

In an example, a second distribution rule matching the node traffic-steering address is obtained from the preset distribution rule set, the second distribution rule including: the node traffic-steering address and a target address of the corresponding target gateway node. Then, the reply packet is transmitted to the target gateway node based on the target address.

In one example, after determining the matched second distribution rule, because the node traffic-steering address and the target address of the target gateway node in the second distribution rule are in one-to-one correspondence, the data distribution device may directly transmit the reply packet to the target gateway node based on the target address.

The data distribution device may alternatively select the target distribution policy from the distribution policy set, and then obtain field information associated with the target distribution policy from the inner protocol header. Then, hash calculation is performed on the field information, to obtain the target hash value. The address matching the target hash value in the address set of the next-hop gateway node is used as the target address, and then the reply packet is transmitted to the target gateway node based on the target address.

In some embodiments, before the reply packet is transmitted to the target gateway node associated with the node traffic-steering address, the destination IP address of the second outer protocol header in the reply packet is modified into the target address.

Operation S209: The target gateway node transmits the reply packet to the transmitting end.

In an example, after receiving the reply packet, the target gateway node executes the specific service logic of the target gateway node, where the gateway logic may be different in different application scenarios. Then, a source IP address of the second outer protocol header of the reply packet is modified into the cluster traffic-steering address. Then, the reply packet is transmitted to the corresponding receiving end.

Operation S201 to operation S206 are a distribution process of the upstream traffic, and operation S207 to operation S209 are a distribution process of the downstream traffic. To describe the distribution process of the upstream traffic and the distribution process of the downstream traffic, descriptions are made below by using an example with reference to a specific implementation scenario.

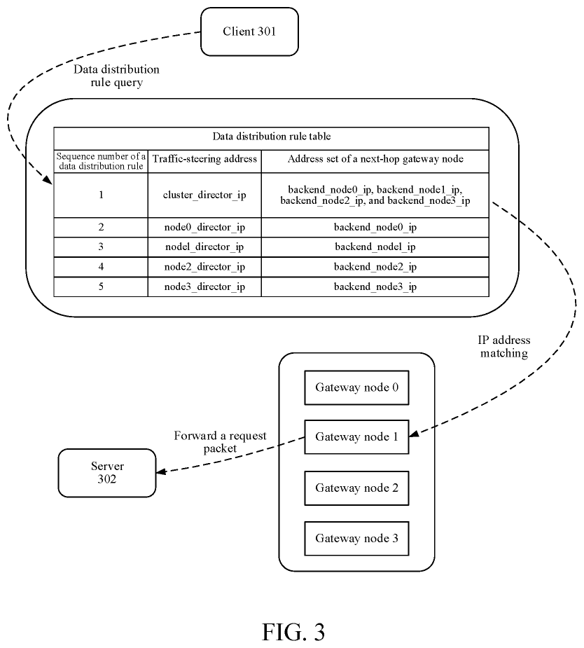

FIG. 3 is a schematic diagram of a method for distribution of upstream traffic according to an embodiment of this disclosure. It is set that a gateway cluster in a gateway cluster layer includes four gateway nodes, which are respectively: a gateway node 0, a gateway node 1, a gateway node 2, and a gateway node 3. A distribution rule table in a data distribution device is shown in the foregoing Table 1, and a distribution policy table in the data distribution device is shown in the foregoing Table 2. A transmitting end is a client 301, and a receiving end is a server 302.

After receiving a request packet transmitted by the client 301, the data distribution device performs packet protocol header parsing on the request packet, to obtain an outer protocol header and an inner protocol header. A destination IP address of the outer protocol header is: a cluster traffic-steering IP address.

The data distribution device queries a distribution rule set based on the cluster traffic-steering IP address, to obtain a hit distribution rule 1, that is, an address set of a next-hop gateway node, including: an IP address of the gateway node 0, an IP address of the gateway node 1, an IP address of the gateway node 2, and an IP address of the gateway node 3.

The data distribution device selects a default distribution policy using a flow as a granularity, and then obtains the following field information from the inner protocol header of the request packet according to the distribution policy using a flow as a granularity: a source IP address, a destination IP address, an identifier of a virtual private cloud, a source port number, and a destination port number. The obtained field information is inputted into a hash algorithm to perform hash calculation, to obtain a target hash value.

Because the target hash value matches the IP address of the gateway node 1, the destination IP address of the outer protocol header of the request packet is modified into: the IP address of the gateway node 1, and the request packet is transmitted to the gateway node 1.

After executing service logic, the gateway node 1 modifies a source IP address of the outer protocol header of the request packet into: a node traffic-steering IP address corresponding to the gateway node 1, and then transmits the request packet to the server 302.

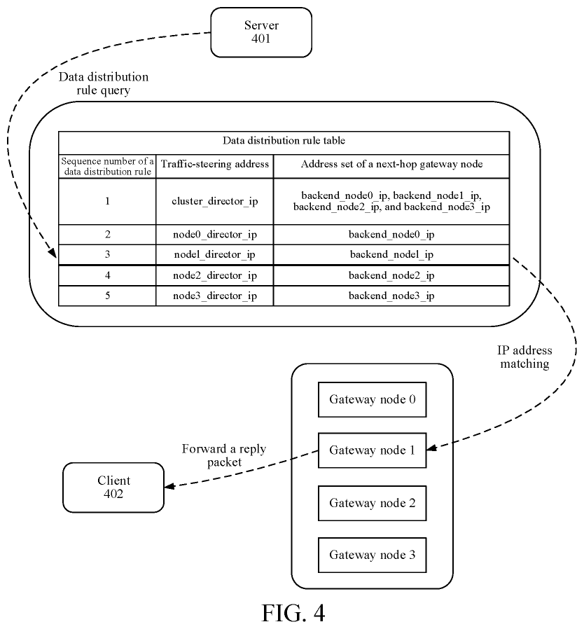

FIG. 4 is a schematic diagram of a method for distribution of downstream traffic according to an embodiment of this disclosure.

After performing service processing on a request packet, a server 401 returns a reply packet to a data distribution device. The data distribution device performs packet protocol header parsing on the reply packet, to obtain a destination IP address of an outer packet header, which is: a node traffic-steering IP address corresponding to a gateway node 1.

The data distribution device queries a distribution rule table based on the node traffic-steering IP address corresponding to the gateway node 1, to obtain a hit distribution rule 3, that is, an address set of a next-hop gateway node, including: an IP address of the gateway node 1.

Because there is only one IP address in the address set of the next-hop gateway node, that is, the IP address of the gateway node 1, the destination IP address of the outer protocol header of the reply packet is modified into: the IP address of the gateway node 1, and the reply packet is transmitted to the gateway node 1.

After executing service logic, the gateway node 1 modifies a source IP address of the outer protocol header of the reply packet into: a cluster traffic-steering address, and then transmits the reply packet to a client 402.

In this embodiment of this disclosure, the data distribution device distributes the traffic through the cluster traffic-steering address or the node traffic-steering address carried in the packet, and a cookie id and a connection hash value of each connection do not need to be stored. In other words, the data distribution device in this disclosure is implemented in a stateless manner. In this way, storage resource occupation can be greatly reduced, thereby improving stability and reliability of the data distribution device.

Second, for the upstream traffic, the data distribution device schedules the request packet to the target gateway node based on the cluster traffic-steering address in the request packet and the inner protocol header of the request packet, and the target gateway node forwards the request packet to the receiving end. For the downstream traffic, the data distribution device also schedules the reply packet to the target gateway node based on the node traffic-steering address that is carried in the reply packet and that corresponds to the target gateway node, and the target gateway node forwards the reply packet to the transmitting end. In this way, the upstream traffic and the downstream traffic are both scheduled to the same target gateway node, connection consistency between upstream traffic and downstream traffic of the same connection is ensured, and traffic jitter is effectively resolved. In addition, when network traffic statistics are collected, accuracy is higher, thereby improving accuracy of traffic rate limiting, and avoiding network congestion.

In some embodiments, for each gateway cluster in the gateway cluster layer, when a new gateway node is added to the gateway cluster through scaling, a distribution rule set is correspondingly updated.

In an example, a distribution rule that is corresponding to a cluster traffic-steering address corresponding to the gateway cluster is first determined, and an IP address of the new gateway node is added to an address set of a next-hop gateway node in the distribution rule. In addition, a node traffic-steering address is allocated to the IP address of the new gateway node, and then a new distribution rule is added to the distribution rule set. The new distribution rule includes: the IP address of the new gateway node and the corresponding node traffic-steering address, and the new gateway node locally stores the corresponding node traffic-steering address.

When performing traffic or data distribution, the data distribution device schedules some connections of gateway nodes originally scheduled to the gateway cluster to the new gateway node, and a manner of scheduling the remaining connections remains unchanged, thereby avoiding a problem of forwarding offset of existing connections between the gateway nodes in the gateway cluster when a quantity of the gateway nodes in the gateway cluster changes, and improving stability and reliability of a backend gateway cluster as a whole.

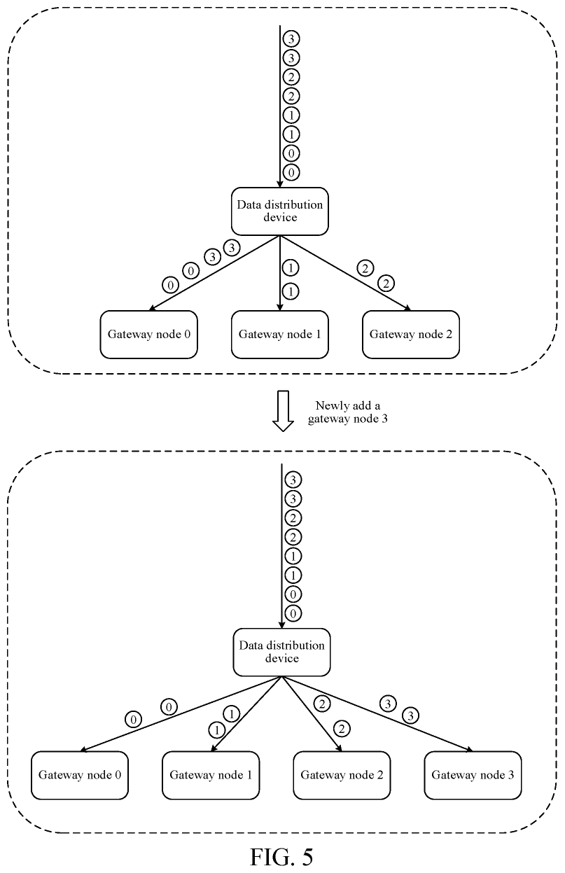

For example, refer to FIG. 5. It is set that a gateway cluster includes a gateway node 0, a gateway node 1, and a gateway node 2. A distribution rule table in a data distribution device is shown in Table 3.

TABLE 3
Distribution rule table

| Sequence number | | |
|---|---|---|
| of a distribution | Traffic-steering | Address set of a |
| rule | address | next-hop gateway node |
| 1 | cluster_director_ip | backend_node0_ip, |
| | | backend_node1_ip, |
| | | and backend_node2_ip |
| 2 | node0_director_ip | backend_node0_ip |
| 3 | node1_director_ip | backend_node1_ip |
| 4 | node2_director_ip | backend_node2_ip |

The data distribution device schedules a packet (\textcircled{0}) of a connection 0 to the gateway node 0, schedules a packet (\textcircled{1}) of a connection 1 to the gateway node 1, schedules a packet (\textcircled{2}) of a connection 2 to the gateway node 2, and schedules a packet (\textcircled{3}) of a connection 3 to the gateway node 0.

When a gateway node 3 is newly added to the gateway cluster, an IP address (backend_node3_ip) of the gateway node 3 is added to the address set of the next-hop gateway node in the distribution rule 1 of the distribution rule table. Then, a distribution rule 5 is added to the distribution rule table, and a traffic-steering address of the distribution rule 5 is: a node traffic-steering IP address (node3_director_ip) corresponding to the gateway node 3; and an address set of a next-hop gateway node in the distribution rule 5 includes: the IP address (backend_node3_ip) of the gateway node 3. For the updated distribution rule table, refer to Table 1. Details are not described herein again.

The data distribution device still schedules the packet of the connection 0 to the gateway node 0, schedules the packet of the connection 1 to the gateway node 1, and schedules the packet of the connection 2 to the gateway node 2. However, the packet of the connection 3 is scheduled to the gateway node 3.

In some embodiments, for each gateway cluster in a gateway cluster layer, when a gateway node is deleted from the gateway cluster, a distribution rule set is correspondingly updated.

In an example, a distribution rule that is corresponding to a cluster traffic-steering address corresponding to the gateway cluster is first determined, and an IP address of the deleted gateway node is deleted from an address set of a next-hop gateway node in the distribution rule. In addition, a distribution rule in which a node traffic-steering address corresponding to the deleted gateway node is located is determined, and then the distribution rule is deleted from the distribution rule set.

When performing traffic or data distribution, the data distribution device schedules connections originally scheduled to the deleted gateway node to other gateway nodes in the gateway cluster, and continues to schedule connections originally scheduled to the other gateway nodes to the gateway nodes, thereby avoiding a problem of forwarding offset of existing connections between the gateway nodes in the gateway cluster when a quantity of the gateway nodes in the gateway cluster changes, and improving stability and reliability of a backend gateway cluster as a whole.

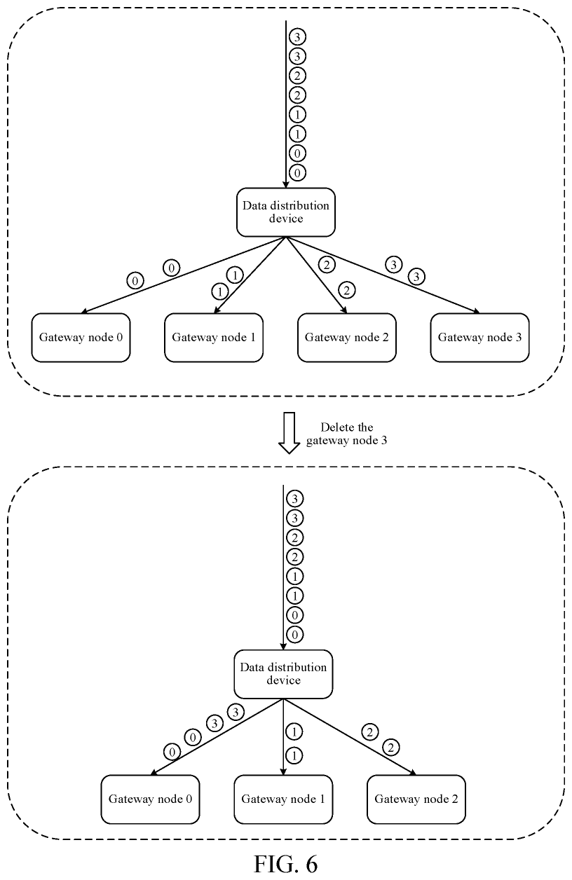

For example, refer to FIG. 6. It is set that a gateway cluster includes a gateway node 0, a gateway node 1, a gateway node 2, and a gateway node 3. A distribution rule table in a data distribution device is shown in Table 1. Details are not described herein again.

The data distribution device schedules a packet (\textcircled{0}) of a connection 0 to the gateway node 0, schedules a packet (\textcircled{1}) of a connection 1 to the gateway node 1, schedules a packet (\textcircled{2}) of a connection 2 to the gateway node 2, and schedules a packet (\textcircled{3}) of a connection 3 to the gateway node 3.

When the gateway node 3 is deleted from the gateway cluster, an IP address (backend_node3_ip) of the gateway node 3 is deleted from the address set of the next-hop gateway node in the distribution rule 1 shown in Table 1. In addition, the distribution rule 5 in Table 1 is deleted. For the updated distribution rule table, refer to Table 3. Details are not described herein again.

When the data distribution device performs traffic or data distribution, the data distribution device still schedules the packet of the connection 0 to the gateway node 0, schedules the packet of the connection 1 to the gateway node 1, and schedules the packet of the connection 2 to the gateway node 2. However, the packet of the connection 3 is scheduled to the gateway node 0.

To ensure that automatic disaster tolerance can be implemented when a backend gateway node is faulty, an embodiment of this disclosure provides at least the following several implementation manners of performing health detection on the gateway node.

Implementation manner 1: For each gateway node in the gateway cluster, a health check policy based on automatic convergence of a dynamic routing protocol is supported, so that automatic disaster tolerance can be implemented when the gateway node is faulty, and the distribution rule on the data distribution device does not need to be modified.

Descriptions are made below by using a target gateway node as an example.

The target gateway node obtains a corresponding plurality of backup gateway nodes, each backup gateway node corresponding to a backup route priority; and the target gateway node issues the backup route priority of each of the plurality of backup gateway nodes, to cause the plurality of backup gateway nodes to take over, based on the corresponding backup route priority, a packet forwarded to the target gateway node when the target gateway node is faulty.

In an example, the target gateway node issues a dynamic route of an IP address of this node through the dynamic routing protocol (for example, a BGP protocol and an OSPF protocol), and the dynamic route corresponds to the highest priority.

In the gateway cluster, the gateway nodes are grouped in pairs (and each gateway node can only belong to one group at the same time), a group in which the target gateway node is located is used as a first-priority backup group, and the other gateway node in the first-priority backup group is used as a backup gateway node.

The target gateway node issues a backup route for an IP address of the backup gateway node, and a priority of the backup route is set as the first backup priority. The first backup priority is lower than the highest priority described above.

In the gateway cluster, the gateway nodes are grouped in pairs again (and each gateway node can only belong to one group at the same time), and the group in which the target gateway node is located is used as a second-priority backup group, a backup gateway node in the second-priority backup group being different from the backup gateway node in the first-priority backup group.

The target gateway node issues a backup route for an IP address of the backup gateway node in the second-priority backup group, and a priority of the backup route is set as the second backup priority, the second backup priority being lower than the first backup priority.

The rest can be deduced by analogy, until each of other gateway nodes in the gateway cluster and the target gateway node form a priority backup group.

When the target gateway node is faulty, traffic of the target gateway node is taken over by a backup gateway node with the first backup priority.

If the backup gateway node with the first backup priority is also faulty, the traffic of the target gateway node is taken over by a backup gateway node with the second backup priority.

If the backup gateway node with the second backup priority is also faulty, the traffic of the target gateway node is taken over by a backup gateway node with the third backup priority. The rest can be deduced by analogy, until there is a backup gateway node taking over the traffic of the target gateway node. If the backup gateway nodes with all the backup priorities are faulty, a traffic forwarding failure message is returned.

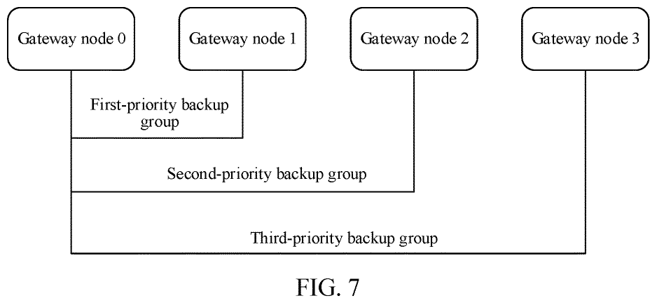

For example, refer to FIG. 7. It is set that a gateway cluster includes four gateway nodes, which are respectively: a gateway node 0, a gateway node 1, a gateway node 2, and a gateway node 3.

The gateway node 0 issues a dynamic route of an IP address of this node through a dynamic routing protocol (for example, a BGP protocol and an OSPF protocol), and the dynamic route corresponds to the highest priority.

The gateway node 0 groups the gateway nodes in pairs in the gateway cluster, to obtain a first-priority backup group {gateway node 0 and gateway node 1}. The gateway node 0 issues a backup route for an IP address of the gateway node 1, and a corresponding priority is set as the first backup priority.

The gateway node 0 groups the gateway nodes in pairs in the gateway cluster, to obtain a second-priority backup group {gateway node 0 and gateway node 2}. The gateway node 0 issues a backup route for an IP address of the gateway node 2, and a corresponding priority is set as the second backup priority.

The gateway node 0 groups the gateway nodes in pairs in the gateway cluster, to obtain a second-priority backup group {gateway node 0 and gateway node 3}. The gateway node 0 issues a backup route for an IP address of the gateway node 3, and a corresponding priority is set as the third backup priority.

In other words, a routing priority order on the gateway node 0 is: an IP address of the gateway node 0>the IP address of the gateway node 1>the IP address of the gateway node 2>the IP address of the gateway node 3.

In a traffic scheduling process, when the gateway node 0 is faulty, traffic of the gateway node 0 is taken over by the gateway node 1.

If the gateway node 1 is also faulty, the traffic of the gateway node 0 is taken over by the gateway node 2.

If the gateway node 2 is also faulty, the traffic of the gateway node 0 is taken over by the gateway node 3.

If the gateway node 3 is also faulty, a traffic forwarding failure message is returned.

Similarly, the gateway node 1, the gateway node 2, and the gateway node 3 may also issue different priority routes in the foregoing manner, and perform traffic takeover based on the different priority routes. A table of a routing priority of each gateway node is specifically shown in Table 4.

TABLE 4

| | Gateway node 0 | Gateway node 1 | Gateway node 2 | Gateway node 3 |
|---|---|---|---|---|
| IP address of the | Highest priority | First backup | Second backup | Third backup |
| gateway node 0 | | priority | priority | priority |
| IP address of the | First backup | Highest priority | Third backup | Second backup |
| gateway node 1 | priority | | priority | priority |
| IP address of the | Second backup | Third backup | Highest priority | First backup |
| gateway node 2 | priority | priority | | priority |
| IP address of the | Third backup | Second backup | First backup | Highest priority |
| gateway node 3 | priority | priority | priority | |

In the foregoing Table 4, backup groups with different priorities corresponding to the gateway node 1 are respectively: a first-priority backup group {gateway node 1 and gateway node 0}; a second-priority backup group {gateway node 1 and gateway node 3}; and a third-priority backup group {gateway node 1 and gateway node 2}. In other words, a routing priority order on the gateway node 1 is: the IP address of the gateway node 1>the IP address of the gateway node 0>the IP address of the gateway node 3>the IP address of the gateway node 2.

Backup groups with different priorities corresponding to the gateway node 2 are respectively: a first-priority backup group {gateway node 2 and gateway node 3}; a second-priority backup group {gateway node 2 and gateway node 0}; and a third-priority backup group {gateway node 2 and gateway node 1}. In other words, a routing priority order on the gateway node 2 is: the IP address of the gateway node 2>the IP address of the gateway node 3>the IP address of the gateway node 0>the IP address of the gateway node 1.

Backup groups with different priorities corresponding to the gateway node 3 are respectively: a first-priority backup group {gateway node 3 and gateway node 2}; a second-priority backup group {gateway node 3 and gateway node 1}; and a third-priority backup group {gateway node 3 and gateway node 0}. In other words, a routing priority order on the gateway node 3 is: the IP address of the gateway node 3>the IP address of the gateway node 2>the IP address of the gateway node 1>the IP address of the gateway node 0.

In this embodiment of this disclosure, a health check policy based on automatic convergence of the dynamic routing protocol sets backup groups with different priorities for each gateway node in a backend gateway cluster. Therefore, when the gateway node is faulty, traffic takeover is automatically performed on the gateway node based on different routing priorities, thereby implementing automatic disaster tolerance, and improving a disaster tolerance capability of the backend gateway cluster.

Implementation 2: Each gateway node in the gateway cluster supports a distributed health check policy. Each data distribution device in a traffic scheduling layer detects whether each gateway node at the backend is in a faulty state. The data distribution device obtains, from a spitting rule set, a first distribution rule and a second distribution rule associated with a target address when detecting that a target gateway node is in the faulty state. Then, the target address is deleted from an address set included in the first distribution rule, and the second distribution rule is deleted from the distribution rule set.

In an example, the data distribution device traverses all the distribution rules in the distribution rule set. Whether all next-hop gateway nodes corresponding to each distribution rule are in the faulty state is detected, and the distribution rule set is updated when all the next-hop gateway nodes are in the faulty state.

Descriptions are made below by using an example in which the next-hop gateway node is the target gateway node described above.

The data distribution device constructs an ICMP request packet whose destination end is the target gateway node. Then, the ICMP request packet is transmitted to the target gateway node.

Whether an ICMP response packet of the target gateway node is received is determined. If the ICMP response packet of the target gateway node is not received for N consecutive times (which may be configured), it is determined that the target gateway node is faulty, the first distribution rule and the second distribution rule associated with the target gateway node are obtained from the distribution rule set, the target address (an IP address of the target gateway node) is deleted from a next-hop gateway node IP address set of the first distribution rule, and the second distribution rule is deleted. If the ICMP response packet of the target gateway node is received, it is determined that the target gateway node is in a survival state, and the distribution rule does not need to be modified.

A status detection manner of another gateway node and a manner of updating the distribution rule set are the same. Details are not described herein again.

In this embodiment of this disclosure, health detection is performed on each gateway node at the backend by using the distributed health check policy, and when it is detected that the gateway node is faulty, a corresponding distribution rule in the distribution rule set is automatically updated, thereby implementing automatic disaster tolerance of the gateway node, and improving a disaster tolerance capability of the backend gateway cluster.

Implementation 3: The data distribution device obtains the first distribution rule and the second distribution rule associated with the target address from the distribution rule set in response to a deletion instruction transmitted by a controller for the target address in the distribution rule set, the deletion instruction being transmitted by invoking a remote interface of the data distribution device by the controller when detecting that the target gateway node is in the faulty state. The target address is deleted from the address set included in the first distribution rule, and the second distribution rule is deleted from the distribution rule set.

In an example, the data distribution device supports a centralized health check policy of the controller. In other words, the data distribution device does not need to autonomously detect a health state of the gateway node at the backend, but provides a remote invoking interface externally for adding, deleting, and modifying the distribution rule. The controller performs centralized health detection. When it is detected that a status of the gateway node at the backend changes, the distribution rule sets in all the splitters are uniformly modified through the remote invoking interface.

Descriptions are made below by using an example in which the gateway node at the backend is the target gateway node described above.

When detecting that the status of the target gateway node changes from the survival state to the faulty state, the controller invokes the remote interface of the data distribution device, deletes the IP address of the target gateway node from the next-hop gateway node IP address set of the first distribution rule corresponding to the target gateway node, and deletes the second distribution rule corresponding to the target gateway node.

When detecting that the status of the target gateway node changes from the faulty state to the survival state, the controller invokes the remote interface of the data distribution device, adds the IP address of the target gateway node to the next-hop gateway node IP address set of the first distribution rule corresponding to the target gateway node, and adds the second distribution rule corresponding to the target gateway node to the distribution rule set.

A status detection manner of another gateway node and a manner of updating the distribution rule set are the same. Details are not described herein again.

In this embodiment of this disclosure, health detection is performed on each gateway node at the backend by using the centralized health check policy, and the corresponding distribution rule in the distribution rule set is adjusted with reference to the remote interface externally provided by the data distribution device. The data distribution device does not need to autonomously detect the health state of the gateway node at the backend. In this way, the disaster tolerance capability of the backend gateway cluster is improved, and resource consumption of the data distribution device is also reduced.

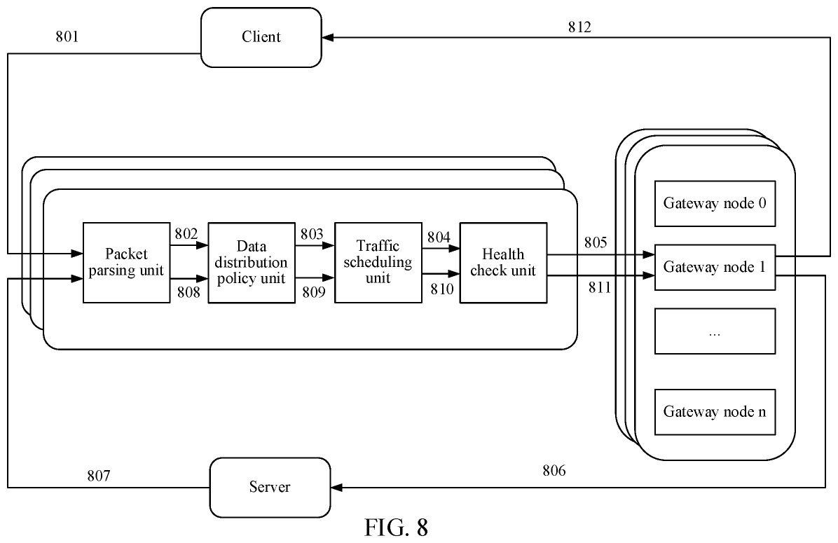

To better explain this embodiment of this disclosure, the following describes a data distribution method according to an embodiment of this disclosure with reference to a specific implementation scenario. Referring to FIG. 8, a process of the method may be interactively performed by a client, a traffic scheduling layer, a gateway cluster layer, and a server, and each data distribution device in the traffic scheduling layer includes: a packet parsing unit, a distribution policy unit, a traffic scheduling unit, and a health check unit. The gateway cluster layer includes a plurality of gateway clusters, and each gateway cluster includes a plurality of gateway nodes.

The following describes a process of forwarding upstream traffic, including the following operations.

Operation 801: The client transmits a request packet to the data distribution device in the traffic scheduling layer.

Operation 802: The packet parsing unit in the data distribution device performs packet protocol header parsing on the request packet, to obtain a cluster traffic-steering IP address and an inner protocol header.

Operation 803: The distribution policy unit in the data distribution device selects a distribution rule and a distribution policy based on the cluster traffic-steering IP address and the inner protocol header, and determines, according to the distribution rule and the distribution policy, a target gateway node (that is, a gateway node 1) for traffic scheduling in the gateway cluster layer.

Operation 804: The health check unit in the data distribution device detects a health state of the gateway node 1.

Operation 805: The traffic scheduling unit in the data distribution device modifies a destination IP address of an outer protocol header of the request packet into: an IP address of the gateway node 1, and schedules the request packet to the gateway node 1.

When it is detected that the gateway node 1 is faulty, the request packet is still forwarded to the gateway node 1. In this case, the request packet is taken over by a backup gateway node in a priority backup group corresponding to the gateway node 1, to implement automatic disaster tolerance.

Operation 806: The gateway node 1 modifies a source IP address of the outer protocol header of the request packet into: a node traffic-steering IP address corresponding to the gateway node 1, and schedules the request packet to the server.

The following describes a process of forwarding downstream traffic, including the following operations.

Operation 807: The server transmits a reply packet to the data distribution device in the traffic scheduling layer.

Operation 808: The packet parsing unit in the data distribution device performs packet protocol header parsing on the reply packet, to obtain a node traffic-steering IP address and an inner protocol header.

Operation 809: The distribution policy unit in the data distribution device selects a distribution rule and a distribution policy based on the node traffic-steering IP address and the inner protocol header, and determines, according to the distribution rule and the distribution policy, the gateway node 1 for traffic scheduling.

Operation 810: The health check unit in the data distribution device detects a health state of each gateway node in the gateway cluster layer.

Operation 811: The data distribution device modifies a destination IP address of an outer protocol header of the reply packet into: the IP address of the gateway node 1, and schedules the reply packet to the gateway node 1.

Operation 812: The gateway node 1 modifies a source IP address of the outer protocol header of the reply packet into: the cluster traffic-steering IP address, and schedules the reply packet to the client.

In this embodiment of this disclosure, the data distribution device distributes the traffic through the cluster traffic-steering address or the node traffic-steering address carried in the packet, and a cookie id and a connection hash value of each connection do not need to be stored. In other words, the data distribution device in this disclosure is implemented in a stateless manner. In this way, storage resource occupation can be greatly reduced, thereby improving stability and reliability of the data distribution device.

Second, in the distribution process, the data distribution device schedules the request packet to the target gateway node based on the cluster traffic-steering address and the inner protocol header of the request packet. Then, the node traffic-steering address corresponding to the target gateway node is carried in the reply packet, and the reply packet is also scheduled to the target gateway node. In this way, the upstream traffic and the downstream traffic are both scheduled to the same target gateway node, connection consistency of upstream traffic and downstream traffic of the same connection is ensured, traffic jitter is resolved effectively, and accuracy is higher when network traffic statistics are collected, thereby improving accuracy of traffic rate limiting, and avoiding network congestion.

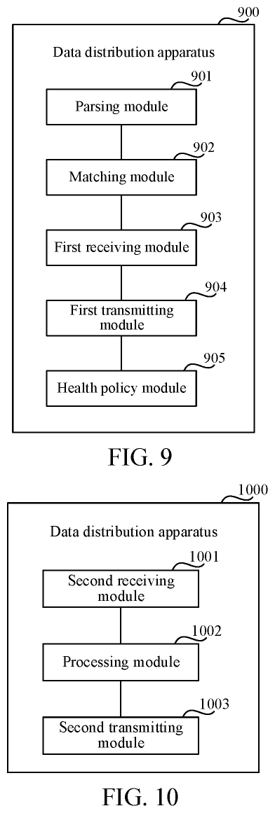

Based on the same technical concept, an embodiment of this disclosure provides a schematic structural diagram of a data distribution apparatus, used in a data distribution device. As shown in FIG. 9, the apparatus 900 includes:

a parsing module 901, configured to parse a request packet transmitted by a transmitting end, to obtain a cluster traffic-steering address and an inner protocol header;

a matching module 902, configured to: determine a gateway cluster corresponding to the cluster traffic-steering address, and obtain an address set corresponding to a plurality of gateway nodes in the gateway cluster; and select a target address matching the inner protocol header from the address set, and transmit the request packet to a target gateway node corresponding to the target address, to cause the target gateway node to add a node traffic-steering address corresponding to the target gateway node to the request packet, and transmit the request packet to a receiving end;

a first receiving module 903, configured to receive, from the receiving end, a reply packet carrying the node traffic-steering address; and

a first transmitting module 904, configured to transmit the reply packet to the target gateway node corresponding to the node traffic-steering address, to cause the target gateway node to transmit the reply packet to the transmitting end.

In some embodiments, the matching module 902 is configured to:
select a target distribution policy matching the inner protocol header from a plurality of distribution policies;
obtain, from the inner protocol header, field information associated with the target distribution policy; and
perform hash calculation on the field information, to obtain a target hash value.

In some embodiments, when the target distribution policy is a distribution policy using a flow as a granularity, the field information includes: a source IP address, a destination IP address, an identifier of a virtual private cloud in which the transmitting end is located, a source port number, and a destination port number in the inner protocol header.

When the target distribution policy is a distribution policy using a service as a granularity, the field information includes: the identifier of the virtual private cloud, the destination IP address, and the destination port number;

when the target distribution policy is a distribution policy using a virtual private cloud as a granularity, the field information includes: the identifier of the virtual private cloud;

and

when the target distribution policy is a distribution policy using a tenant as a granularity, the field information includes: a tenant identifier corresponding to the identifier of the virtual private cloud.

In some embodiments, the parsing module 901 is configured to:
perform packet protocol header parsing on the request packet, to obtain a first outer protocol header and the inner protocol header; and
determine a destination IP address in the first outer protocol header as the cluster traffic-steering address.

The parsing module 901 is further configured to:
perform packet protocol header parsing on the reply packet, to obtain a second outer protocol header; and
determine a destination IP address in the second outer protocol header as the node traffic-steering address.

In some embodiments, the first transmitting module 904 is further configured to:
modify the destination IP address of the first outer protocol header into the target address before transmitting the request packet to the target gateway node.
modify the destination IP address of the second outer protocol header into the target address before transmitting the reply packet to the target gateway node.

In some embodiments, the matching module 902 is configured to:
obtain a first distribution rule matching the cluster traffic-steering address from a preset distribution rule set, the first distribution rule including: the cluster traffic-steering address and the address set.

In some embodiments, the matching module 902 is configured to:
obtain a second distribution rule matching the node traffic-steering address from the preset distribution rule set, the second distribution rule including: the node traffic-steering address and a target address of the target gateway node; and transmit the reply packet to the target gateway node based on the target address.

In some embodiments, the apparatus further includes a health policy module 905.

The health policy module 905 is configured to:
obtain the first distribution rule and the second distribution rule associated with the target address from the distribution rule set in response to a deletion instruction transmitted by a controller for the target address in the distribution rule set, the deletion instruction being transmitted by invoking a remote interface of a data distribution device by the controller when detecting that the target gateway node is in a faulty state;
delete the target address from the address set included in the first distribution rule; and
delete the second distribution rule from the distribution rule set.

In some embodiments, the health policy module 905 is configured to:
obtain, from the spitting rule set, the first distribution rule and the second distribution rule associated with the target address when detecting that the target gateway node is in a faulty state;
delete the target address from the address set included in the first distribution rule; and
delete the second distribution rule from the distribution rule set.

Based on the same technical concept, an embodiment of this disclosure provides a schematic structural diagram of a data distribution apparatus, used in a target gateway node. As shown in FIG. 10, the apparatus 1000 includes:
a second receiving module 1001, configured to receive a request packet transmitted by a data distribution device based on a target address corresponding to a target gateway node, the data distribution device receiving the request packet from a transmitting end, parsing the request packet to obtain a cluster traffic-steering address and an inner protocol header, determining a gateway cluster corresponding to the cluster traffic-steering address, obtaining an address set corresponding to a plurality of gateway nodes in the gateway cluster, and selecting a target address matching the inner protocol header from the address set;
a processing module 1002, configured to add a node traffic-steering address corresponding to the target gateway node to the request packet; and
a second transmitting module 1003, configured to transmit the request packet to a receiving end, the data distribution device receiving a reply packet carrying the node traffic-steering address from the receiving end,
the second receiving module 1001 being further configured to receive the reply packet transmitted by the data distribution device based on the node traffic-steering address; and
the second transmitting module 1003 being further configured to transmit the reply packet to the transmitting end.

In some embodiments, the processing module 1002 is configured to:
transmit the request packet to the receiving end after modifying a source internet protocol IP address of a first outer protocol header of the request packet into the node traffic-steering address.

A source internet protocol IP address of a second outer protocol header of the reply packet is modified into the cluster traffic-steering address before the reply packet is transmitted to the transmitting end.

In some embodiments, the processing module 1002 is further configured to:
obtain a plurality of backup gateway nodes corresponding to the target gateway node, each backup gateway node corresponding to a backup route priority; and
issue the backup route priority of each of the plurality of backup gateway nodes, to cause the plurality of backup gateway nodes to take over, based on the corresponding backup route priority, a packet forwarded to the target gateway node when the target gateway node is faulty.

In this embodiment of this disclosure, the data distribution device distributes traffic through the cluster traffic-steering address or the node traffic-steering address carried in the packet, and a cookie id and a connection hash value of each connection do not need to be stored. In other words, the data distribution device in this disclosure is implemented in a stateless manner. In this way, storage resource occupation can be greatly reduced, thereby improving stability and reliability of the data distribution device.

Second, for upstream traffic, the data distribution device schedules the request packet to the target gateway node based on the cluster traffic-steering address in the request packet and the inner protocol header of the request packet, and the target gateway node forwards the request packet to the receiving end. For downstream traffic, the data distribution device also schedules the reply packet to the target gateway node based on the node traffic-steering address that is carried in the reply packet and that corresponds to the target gateway node, and the target gateway node forwards the reply packet to the transmitting end. In this way, the upstream traffic and the downstream traffic are both scheduled to the same target gateway node, connection consistency between upstream traffic and downstream traffic of the same connection is ensured, and traffic jitter is effectively resolved. In addition, when network traffic statistics are collected, accuracy is higher, thereby improving accuracy of traffic rate limiting, and avoiding network congestion.

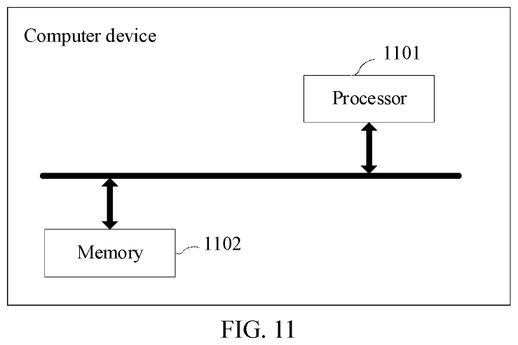

Based on the same technical concept, an embodiment of this disclosure provides a computer device. The computer device may be the transmitting end, the data distribution device, the gateway node, and the receiving end shown in FIG. 1. As shown in FIG. 11, the computer device includes processing circuitry (such as at least one processor 1101) and a memory 1102 connected to the at least one processor. A specific connection medium between the processor 1101 and the memory 1102 is not limited in this embodiment of this disclosure. An example in which the processor 1101 is connected to the memory 1102 through a bus is used in FIG. 11. The bus may include an address bus, a data bus, a control bus, or the like.

In this embodiment of this disclosure, the memory 1102 may include a non-transitory computer-readable storage medium that stores instructions capable of being executed by the at least one processor 1101, and the at least one processor 1101 may perform the operations of the foregoing data distribution method by executing the instructions stored in the memory 1102.

The processor 1101 is a control center of the computer device, and may be connected to various parts of the computer device by using various interfaces and lines. By running or executing the instructions stored in the memory 1102 and invoking data stored in the memory 1102, data distribution is implemented. In some embodiments, the processor 1101 may include one or more processing units. The processor 1101 may integrate an application processor and a modem processor. The application processor mainly processes an operating system, a user interface, an application, and the like. The modem processor mainly processes wireless communication. The foregoing modem processor may not be integrated into the processor 1101. In some embodiments, the processor 1101 and the memory 1102 may be implemented on the same chip. In some embodiments, the processor 1101 and the memory 1102 may be separately implemented on independent chips.

The processor 1101 may be a general-purpose processor, such as a central processing unit (CPU), a digital signal processor, an application specific integrated circuit (ASIC), a field programmable gate array or another programmable logic device, a discrete gate, a transistor logic device, or a discrete hardware component, and may implement or perform the methods, operations, and logic block diagrams disclosed in the embodiments of this disclosure. The general-purpose processor may be a microprocessor, any processor, or the like. The operations of the method disclosed in combination with embodiments of this disclosure may be directly performed by a hardware processor, or may be performed through a combination of hardware and software modules in the processor.

The memory 1102 is used as a non-volatile computer-readable storage medium, and may be configured to store a non-volatile software program, and a non-volatile computer-executable program and module. The memory 1102 may include at least one type of storage medium, for example, may include a flash memory, a hard disk, a multimedia card, a card-type memory, a random access memory (RAM), a static random access memory (SRAM), a programmable read-only memory (PROM), a read-only memory (ROM), an electrically erasable programmable read-only memory (EEPROM), a magnetic memory, a magnetic disk, an optical disc, and the like. The memory 1102 is any other medium that can be configured to carry or store expected program code in a form of instructions or a data structure and that can be accessed by the computer device, but is not limited thereto. The memory 1102 in this embodiment of this disclosure may further be a circuit or any other apparatus capable of implementing a storage function, which is configured to store program instructions and/or data.

Based on the same concept, an embodiment of this disclosure provides a computer-readable storage medium, having a computer program capable of being executed by a computer device stored therein, when the program is run on the computer device, the computer device being caused to perform the operations of the foregoing data distribution method.

Based on the same concept, an embodiment of this disclosure provides a computer program product, including a computer program stored in a computer-readable storage medium, the computer program including program instructions, and when the program instructions are executed by a computer device, the computer device being caused to perform the operations of the foregoing data distribution method.

A person skilled in the art is to understand that the embodiments of the present disclosure may be provided as a method, or a computer program product. Therefore, the present disclosure can use a form of hardware only embodiments, software only embodiments, or embodiments combining software and hardware. Moreover, the present disclosure can use a form of a computer program product implemented on one or more computer-usable storage media (including, but not limited to, a disk memory, a compact disc read-only memory (CD-ROM), an optical memory, and the like) that include computer-usable program code.

The present disclosure is described with reference to the flowcharts and/or block diagrams of the methods, the devices (systems), and the computer program products according to the embodiments of the present disclosure. Computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer device or the processor of the another programmable data processing device generate an apparatus for implementing a specific function in one or more processes in the flowcharts and/or one or more blocks in the block diagrams.

These computer program instructions may be stored in a computer-readable memory that can instruct the computer device or the another programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may further be loaded onto the computer device or the another programmable data processing device, so that a series of operations and steps are performed on the computer device or the another programmable device, thereby generating computer device-implemented processing. Therefore, the instructions executed on the computer device or the another programmable device provide steps for implementing a specific function in one or more processes in the flowcharts and/or in one or more blocks in the block diagrams.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., a computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions correspond to non-limiting embodiments of this disclosure, and are not intended to limit this disclosure. Any modification, equivalent replacement, or improvement made within the spirit and principle of this disclosure are within the scope of this disclosure.

What is claimed is:

1. A data distribution method, comprising:
obtaining a cluster traffic-steering address and an inner protocol header of a first packet from a first end;
obtaining an address set corresponding to a plurality of gateway nodes in a gateway cluster based on the cluster traffic-steering address;
selecting, by processing circuitry of a data distribution device, a target address from the address set based on the inner protocol header;
transmitting, by the processing circuitry, the first packet to a target gateway node corresponding to the target address, the target gateway node being configured to add address information to the first packet based on a node traffic-steering address corresponding to the target gateway node to the first packet and to transmit the first packet with inclusion of the node traffic-steering address to a second end;
receiving a second packet in association with the first packet from the second end, the second packet including the node traffic-steering address; and
transmitting the second packet to the target gateway node corresponding to the node traffic-steering address, the target gateway node being further configured to transmit the second packet to the first end.

2. The method according to claim 1, wherein the selecting the target address comprises:
selecting a target distribution policy from a plurality of distribution policies based on the inner protocol header;
obtaining, from the inner protocol header, field information associated with the target distribution policy;
performing hash calculation on the field information, to obtain a target hash value; and
determining the target address from the address set based on the target hash value.

3. The method according to claim 2, wherein
when the target distribution policy is a flow granularity-based distribution policy, the field information includes one or more of a source internet protocol IP address, a destination IP address, an identifier of a virtual private cloud in which the first end is located, a source port number, or a destination port number;
when the target distribution policy is a service granularity-based distribution policy, the field information includes one or more of the identifier of the virtual private cloud, the destination IP address, or the destination port number;
when the target distribution policy is a virtual private cloud granularity-based distribution policy, the field information includes the identifier of the virtual private cloud; and
when the target distribution policy is a tenant granularity-based distribution policy, the field information includes a tenant identifier corresponding to the identifier of the virtual private cloud.

4. The method according to claim 1, wherein the obtaining the cluster traffic-steering address and the inner protocol header of the first packet comprises:
performing packet protocol header parsing on the first packet, to obtain a first outer protocol header and the inner protocol header; and
determining a destination IP address in the first outer protocol header as the cluster traffic-steering address.

5. The method according to claim 1, further comprising:
performing packet protocol header parsing on the second packet, to obtain a second outer protocol header; and
determining a destination IP address in the second outer protocol header as the node traffic-steering address.

6. The method according to claim 1, further comprising:
modifying a destination IP address in a first outer protocol header of the first packet to indicate the target address before the first packet is transmitted to the target gateway node.

7. The method according to claim 5, further comprising:
modifying the destination IP address in the second outer protocol header to indicate the target address before the second packet is transmitted to the target gateway node.

8. The method according to claim 1, wherein the obtaining the address set comprises:
obtaining a first distribution rule based on the cluster traffic-steering address from a candidate distribution rule set, the first distribution rule including the cluster traffic-steering address and the address set.

9. The method according to claim 1, further comprising:
obtaining a second distribution rule based on the node traffic-steering address from a candidate distribution rule set, the second distribution rule including the node traffic-steering address and the target address of the target gateway node,
wherein the transmitting the second packet to the target gateway node is based on the target address indicated by the second distribution rule.

10. The method according to claim 1, further comprising:
obtaining a first distribution rule and a second distribution rule associated with the target address from a candidate distribution rule set in response to a deletion instruction for the target address in the candidate distribution rule set, the first distribution rule corresponding to a request path, the second distribution rule corresponding to a response path, and the deletion instruction being generated when the target gateway node is in a faulty state;
deleting the target address from the address set included in the first distribution rule; and
deleting the second distribution rule from the candidate distribution rule set.

11. The method according to claim 1, further comprising:
obtaining, from a candidate distribution rule set, a first distribution rule and a second distribution rule associated with the target address when the target gateway node is in a faulty state, the first distribution rule corresponding to a request path, and the second distribution rule corresponding to a response path;
deleting the target address from the address set included in the first distribution rule; and
deleting the second distribution rule from the candidate distribution rule set.

12. A data communication method, comprising:
receiving, by processing circuitry of a target gateway node, a first packet from a data distribution device based on a target address corresponding to the target gateway node, the data distribution device being configured to obtain a cluster traffic-steering address and an inner protocol header of the first packet from a first end, obtain an address set corresponding to a plurality of gateway nodes in a gateway cluster based on the cluster traffic-steering address, and obtain the target address from the address set based on the inner protocol header;
adding, by the processing circuitry, a node traffic-steering address corresponding to the target gateway node to the first packet;
transmitting the first packet with inclusion of the node traffic-steering address to a second end;
receiving, by the processing circuitry, a second packet in association with the first packet from the data distribution device, the data distribution device being configured to receive the second packet from the second end, and the second packet including the node traffic-steering address; and
transmitting the second packet to the first end.

13. The method according to claim 12, wherein the adding the node traffic-steering address corresponding to the target gateway node to the first packet comprises:
modifying a source internet protocol IP address of a first outer protocol header of the first packet to indicate the node traffic-steering address.

14. The method according to claim 12, further comprising:
modifying a source internet protocol IP address of a second outer protocol header of the second packet to indicate the cluster traffic-steering address before the second packet transmitted to the second end.

15. The method according to claim 12, further comprising:
obtaining a plurality of backup gateway nodes corresponding to the target gateway node, each backup gateway node corresponding to a backup route priority; and
issuing the backup route priority of each of the plurality of backup gateway nodes, to cause the plurality of backup gateway nodes to take over, based on the corresponding backup route priority, a packet forwarded to the target gateway node when the target gateway node is faulty.

16. A data distribution apparatus, comprising:
processing circuitry configured to:
obtain a cluster traffic-steering address and an inner protocol header of a first packet from a first end;
obtain an address set corresponding to a plurality of gateway nodes in a gateway cluster based on the cluster traffic-steering address;
select a target address from the address set based on the inner protocol header;
transmit the first packet to a target gateway node corresponding to the target address, the target gateway node being configured to add address information to the first packet based on a node traffic-steering address corresponding to the target gateway node to the first packet and to transmit the first packet with inclusion of the node traffic-steering address to a second end;
receive a second packet in association with the first packet from the second end, the second packet including the node traffic-steering address; and
transmit the second packet to the target gateway node corresponding to the node traffic-steering address, the target gateway node being further configured to transmit the second packet to the first end.

17. The apparatus according to claim 16, wherein the processing circuitry is configured to:
select a target distribution policy from a plurality of distribution policies based on the inner protocol header;
obtain, from the inner protocol header, field information associated with the target distribution policy;
perform hash calculation on the field information, to obtain a target hash value; and
determine the target address from the address set based on the target hash value.

18. The apparatus according to claim 17, wherein
when the target distribution policy is a flow granularity-based distribution policy, the field information includes one or more of a source internet protocol IP address, a destination IP address, an identifier of a virtual private cloud in which the first end is located, a source port number, or a destination port number;
when the target distribution policy is a service granularity-based distribution policy, the field information includes one or more of the identifier of the virtual private cloud, the destination IP address, or the destination port number;
when the target distribution policy is a virtual private cloud granularity-based distribution policy, the field information includes the identifier of the virtual private cloud; and
when the target distribution policy is a tenant granularity-based distribution policy, the field information includes a tenant identifier corresponding to the identifier of the virtual private cloud.

19. The apparatus according to claim 16, wherein the processing circuitry is configured to:
obtain a first distribution rule based on the cluster traffic-steering address from a candidate distribution rule set, the first distribution rule including the cluster traffic-steering address and the address set.

20. The apparatus according to claim 16, the processing circuitry is configured to:
obtain a second distribution rule based on the node traffic-steering address from a candidate distribution rule set, the second distribution rule including the node traffic-steering address and the target address of the target gateway node,
wherein the second packet to the target gateway node is transmitted based on the target address indicated by the second distribution rule.
